(19) United States
(12) Patent Application Publication
(10) Pub. No.: US 2016/0371667 A1
(43) Pub. Date: Dec. 22, 2016

(54) Home Inventory Management Device and System

(71) Applicants: Akeem Adetunji, Mt. Airy, MD (US); Adejoke Uiyoshioria, Upper Marlboro, MD (US); Bashir Adetunji, Kent (GB)

(72) Inventors: Akeem Adetunji, Mt. Airy, MD (US); Adejoke Uiyoshioria, Upper Marlboro, MD (US); Bashir Adetunji, Kent (GB)

(21) Appl. No.: 15/186,445

(22) Filed: Jun. 18, 2016

Related U.S. Application Data
(60) Provisional application No. 62/181,321, filed on Jun. 18, 2015.

(51) Int. Cl. G06Q 20/20; G06K 7/14; G06K 19/06; G06Q 10/08

(52) U.S. Cl. CPC G06Q 20/203; G06Q 10/0875; G06K 7/1413; G06K 19/06028

(57) ABSTRACT

Disclosed is a system and method for inventorying items, for example, non-commercial items. In one embodiment, the system includes a mat that is configured to automatically identify low inventory of items by determine any anomaly in weight of an item by recognizing inconsistencies in the weight of the item placed thereon versus the expected weight of the item being monitored. The mat is communicably coupled to a user device that can access an online store for placing an order to replenish low supply items.

### CROSS-REFERENCE TO RELATED APPLICATIONS

This application claims the benefit of U.S. Provisional Patent Application No. 62/181,321, filed Jun. 18, 2015, which is hereby incorporated by reference in its entirety.

### FIELD OF THE INVENTION

The present invention relates generally to devices, systems, and methods for conducting an inventory of various non-commercial items. More particularly, the present invention is directed to devices, systems, and methods for monitoring the inventory of non-commercial items by weight and a system for replenishing those items automatically.

### BACKGROUND OF THE INVENTION

An average household purchases hundreds of household items and groceries on a regular basis. These household items and groceries are stored in various parts of the house. Thus, in order to determine whether certain household items or grocery items are running low, individuals must regularly check various parts of the house, including refrigerators, cabinets, drawers, and other storage compartments and rooms. Thereafter, the individuals generally create a shopping list to make sure that low-running items are replenished for future use.

This traditional method of monitoring the inventory of various non-commercial items and groceries is both time consuming and inconvenient. Additionally, it can be of particular annoyance to make a trip to a store to buy only one or two items. In this regard, the invention described herein addresses this problem.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Some embodiments include, for example, devices, systems, and methods of inventorying non-commercial items. In one embodiment, the system comprises a mat that is communicably coupled to a network and at least one network-enabled user device, wherein the mat is configured to identify and measure the weight of an item placed thereon. Preferably, the mat is configured to continuously monitor the weight of the item so as to determine whether the weight of the item is below a predetermined threshold weight, wherein the predetermined threshold weight is the weight of the item when the item is running low. When the weight of the item is below the predetermined threshold weight, the mat is configured to transmit a notification to one or more network-enabled user devices such as a mobile device.

Upon receiving notification on a device, an end user can monitor the inventory of the item and then place an order to replenish the item. Alternatively, the user can place an order for a different item, additional items, or cancel existing orders. In some embodiments, the mat is configured to automatically place an order to replenish the item. In this way, the user is not required to place the order, increasing convenience to the user. The order is forwarded to a merchant server that processes the order by forwarding the order request to a storefront or a merchant that can fulfill the order.

Some embodiments of the system include a computing system including a memory having stored thereon accountability based instructions, and a processor to execute the instructions, causing the processor to identify a non-commercial item and monitor the item's weight in order to manage the inventory of the item. In managing the inventory, the processor is further configured to prompt the user to replenish the item, whereby the user can place an order for the item via, for example, a website. It is noted that the present system can comprise other types of user input terminal such as a web application, mobile application, and other types of non-downloadable or downloadable software application. In this regard, the software application is configured to provide a user interface (UI), for example, a graphic user interface (GUI) for receiving user input to place the order.

In some embodiments, the processor is further configured to transmit order confirmation to the merchant server, wherein the merchant server is communicably coupled to a database for storing order information such as an order number and customer data associated with each order number. The merchant server is configured to relay the order request to a store or a merchant to fulfill the order, wherein the store or the merchant can deliver the item to the user.

In the light of the foregoing, these and other objectives are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a high-level block diagram of the present system.

FIG. 2 is a block diagram of a machine in the example form of a computer system within which a set of instructions, for causing the machine to perform any one or more of the methods discussed herein, may be executed.

FIGS. 3A and 3B show an exemplary work flowchart of the present method.

### DETAILED DESCRIPTION OF THE INVENTION

The present invention is directed towards a device, system, and a method of managing inventory for non-commercial goods. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

It is to be appreciated that determinations or inferences referenced throughout the subject specification can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a personal computer (PC), a desktop computer, a mobile computer, a laptop, a tablet computer, a server computer, a handheld device, a personal digital assistant (PDA), a wireless communication device, a smart phone, a non-portable device, a wireless access point (AP), a wired or wireless router, a wired or wireless modem, a wired or wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of long term evolution (LTE), a device which incorporates a global positioning system (GPS) receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, or the like.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form.

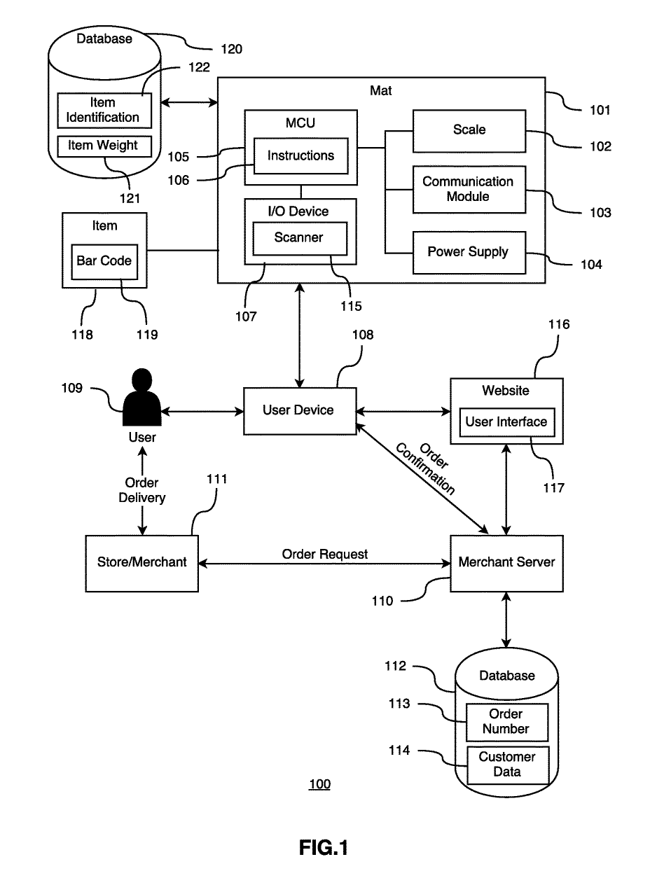

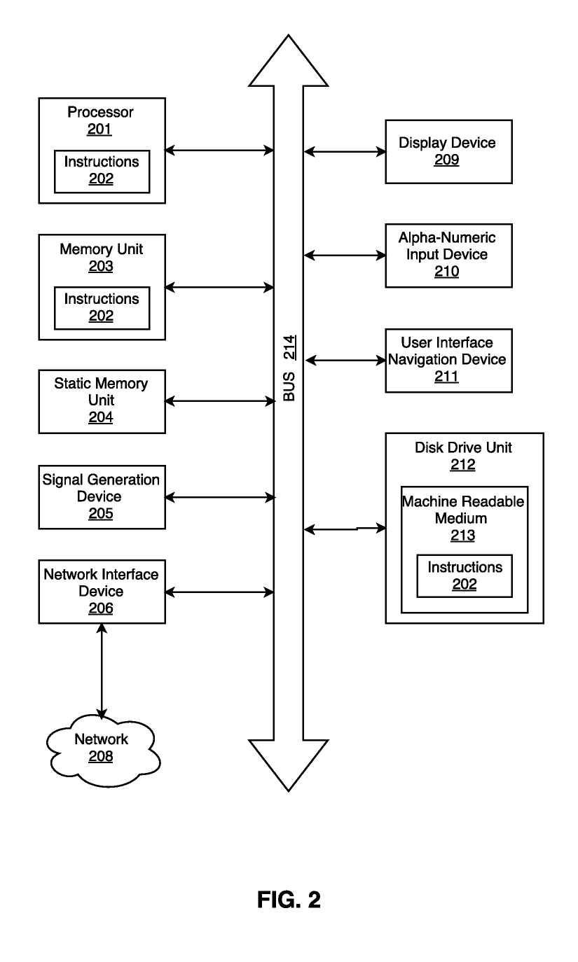

Some demonstrative embodiments are described herein in the context of inventorying non-commercial goods. Referring now to FIGS. 1 and 2, there are shown exemplary block diagrams of the present system in accordance with some demonstrative embodiments. The present system 100 comprises a mat 101 comprising a microcontroller (MCU) 105 having instructions 106 stored thereon, or a similar processing unit that is connected to a scale 102, a communication module 103, a power supply 104 (e.g., batteries), and an input/output (I/O) device 107. In some embodiments, the I/O device 107 comprises a scanner 115, for example, a bar code scanner, or other types of image capturing means such as a camera for scanning bar codes to identify various non-commercial items 118 placed on the mat 101.

In a preferred embodiment, the exterior of the mat 101 resembles a conventional mat that is shaped and dimensioned to support items 118 on an upper surface thereof. The mat 101 is configured to identify items 118 by its weight and/or by its bar code 119 or QR code attached thereto or associated therewith. In this regard, each mat 101 is preferably configured for use with a single item 118 to increase accuracy thereof (e.g., laundry detergent by itself, but not laundry detergent and cleaning wipes). It is noted that the bar code 119 comprises data associated with the item 118 on which it is attached. Without limitation, the data comprises, for example, identification of the item 118 (e.g., name of the item, item type, item category, store where the item is sold or available, price of the item, item color, item size, etc.), and the weight of the item 118 (i.e., the starting weight of the item and the predetermined threshold weight of the item). As noted herein, the starting weight of the item 118 is the weight of the item 118 when the item 118 is sufficiently stocked or does not need to be replenished. In contrast, the predetermined threshold weight is the weight of the item 118 when the item is running low, or when the item 118 needs to be replenished.

In some embodiments, the MCU 105 is configured to locally store item identification and item weight for each item 118 therein. Alternatively, the mat 101 is in communication with a wirelessly connected database 120 that stores item identification 122 and item weight 121 for each item 118. The MCU 105 is configured to determine any anomaly in weight by recognizing inconsistencies in the weight of the items 118 placed thereon versus the expected weight of the item 118 being monitored. The scale 102 constantly measures (i.e., at a regular time interval) the weight of the item 101 and relays the measured weight to the MCU 105, which determines whether the measured weight exceeds or falls below the predetermined threshold weight.

If the weight of the item 118 is below the predetermined threshold weight, the communication module 103 transmits a notification to a user device 108 that is operated by an end user 109, a consumer, or a customer, wherein the user device 108 is connected to a network (e.g., the Internet, LAN, etc.). Without limitation, the user device 108 comprises a computer, a mobile phone, a personal digital assistant (PDA), a tablet computer, an e-reader, and/or a terminal that is configured to automatically perform one or more inventory based operations described herein. In this regard, the user device 108 comprises computer-related components as shown in FIG. 2. In some embodiments, the user 109 can customize the setting so as to lower or raise the predetermined threshold weight manually via, for example, the user device 108.

In some embodiments, the present system 100 includes an interface 117 to interface among the user device 108, the mat 101, and other components of the system 100. The interface 117 may be implemented as a part of the user device 108, the mat 101, and/or as part of any suitable system or module. In one example, the interface 117 may be implemented, for example, as middleware, as part of any suitable application, and/or as part of a server. The interface 117 may be implemented using any suitable hardware components and/or software components, for example, processors, controllers, memory units, storage units, input units, output units, communication units, operating systems, and applications. In some embodiments, the interface 117 may include, or may be part of a website 116, a web-based application, a webpage, a mobile application, a standalone application, a plug-in, a rich content component, or the like.

In some embodiments, the interface 117 is configured to allow the user 109 to enter commands; to input and receive order requests for items 118; to process order requests; to transact order requests; to transmit messages, for example, via direct messaging, message boards, or forums; to make status updates; to analyze and generate reports about order requests; to analyze any market information such as prices and the like; to monitor transactions; and/or to otherwise control and/or analyze order requests as described herein.

The user device 108 is configured to display notifications on its display screen via, for example, the user interface 117, in a formal of text, email, banner notification, and the like, depending upon embodiment. In some embodiments, the notification may contain a link on which the user 109 can activate to view details about the item 118 that may be running low. For instance, the link may direct the user 109 to a website or a webpage where the user 109 can view the item 118, the quantity of the item 118 remaining, and the like. In this way, the user can verify that the item is running low before taking further actions. In some embodiments, the link is configured direct the user 109 to a website 116 or an online store where the user 109 can place an order to replenish the item 118.

In this way, the user device 108 is configured to access a website 116, webpage, or other types of non-downloadable software that is managed by a merchant server 110, vendor, or an online store. In some embodiments, the user device 108 comprises a software application installed thereon. The website 116 and the software application provides a user interface 117 that includes a virtual storefront, or that provides a link to a third party app store. In this way, the user can place and confirm an order for the item that is running low, place an order for additional item, place an order for a different item, and/or cancel an automatic order upon receiving notification from the mat 101 on the user device 108.

The order confirmation is transmitted from the user device 108 to the merchant server 110. In some embodiments, the merchant server 110 is communicably coupled with a database 112 for storing order numbers 113, wherein each order number 113 is associated with order information (e.g., order request that includes items requested/purchased) and customer data 114. The merchant server 110 is configured to forward an order request associated with the order confirmation to a store entity or a merchant 111 to fulfill the order. The order is then delivered to the user 109. More particularly, the item 118 associated with the order is shipped or delivered to a mailing address associated with the user 109.

In some embodiments, the user device 108, the merchant server 110, and the databases 112, 120 may be implemented using suitable hardware components and/or software components. For example, FIG. 2, shows a block diagram of machine in the example form of a computer system within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system includes a processor 201 (e.g., a central processing unit (CPU), a graphics processing unit (GPU)), a main memory unit 203, and a static memory unit 204, which communicate with each other via a bus 214. The computer system may further include a display device 209 (e.g., a liquid crystal display (LCD) or a cathode ray tube (CRT)). The computer system also includes an alphanumeric input device 210 (e.g., a keyboard), a user interface (UI) navigation device 211 (e.g., a mouse), a disk drive unit 212, a signal generation device 215 (e.g., a speaker), and a network interface device 206 that is configured to establish a connection with a network 208.

The disk drive unit 212 includes a machine-readable medium 213 on which is stored one or more sets of data structures and instructions 202 (e.g., software) embodying or utilized by any one or more of the methods or functions described herein. The instructions 202 may also reside, completely or at least partially, within the main memory unit 203 and/or within the processor 201 during execution thereof by the computer system. In this regard, the main memory unit 203 and the processor 201 are also considered machine-readable media.

While the machine-readable medium 213 is shown in an example embodiment to be a single medium, the term “machine-readable medium” may include a single medium or multiple media (e.g., a centralized or distributed database, and/or associated caches and servers) that store the one or more instructions 202 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 202 may further be transmitted or received over a computer network 208 using a transmission medium. The instructions 202 may be transmitted using the network interface device 206 and any one of a number of well-known transfer protocols. The term “transmission medium” shall be taken to include any intangible medium that is capable of storing, encoding, or carrying instructions for execution by the machine, and includes digital or analog communications signals or other intangible media to facilitate communication of such software.

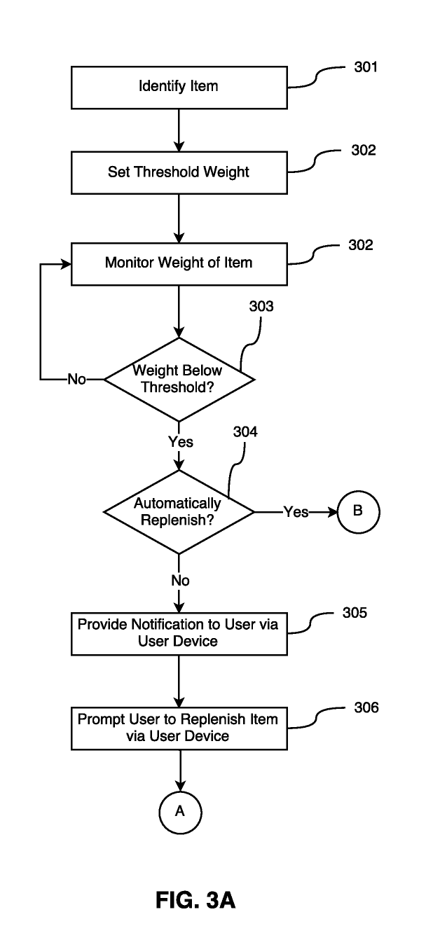

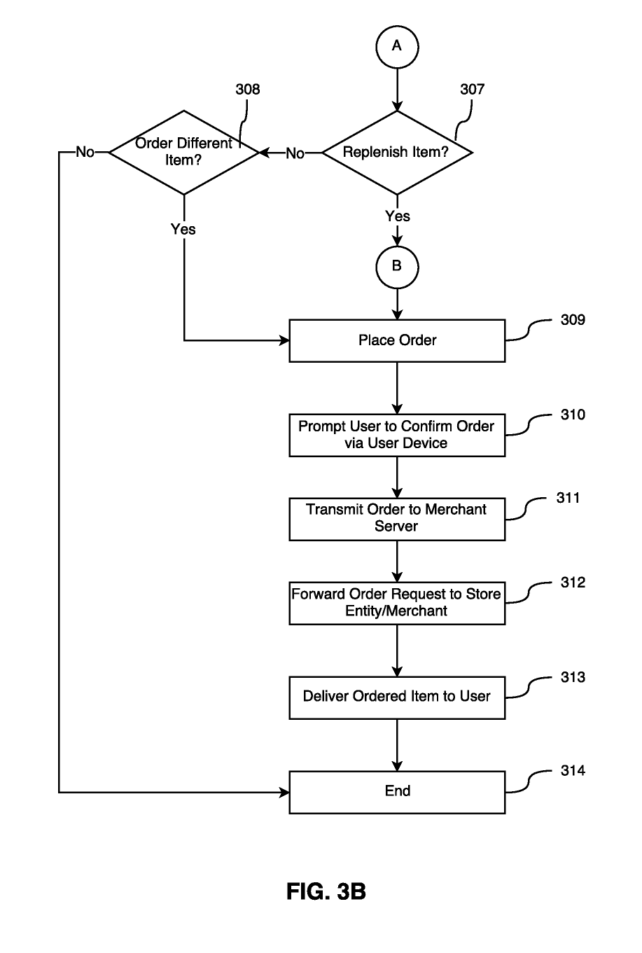

Reference is also made to FIGS. 3A and 3B, which schematically illustrate exemplary methods of the present invention. In some embodiments, one or more operations of FIGS. 3A and 3B may be performed by one or more elements of the present system in FIGS. 1 and 2.

As indicated in block 301, the present method generally begins with identifying an item 118 (FIG. 1) that is placed on the mat 101 (FIG. 1). In one embodiment, the mat 101 (FIG. 1) identifies the item 118 (FIG. 1) by scanning the item's bar code 119 (FIG. 1) via the scanner 115 (FIG. 1) and obtaining information (e.g., item identification 122 (FIG. 1)) about the item 118 (FIG. 1), for example, from the database 120 (FIG. 1) that is associated with the bar code 119 (FIG. 1). In this way, the mat 101 (FIG. 1) is configured to scan the item 118 (FIG. 1) and retrieve all associated data therewith, including the item name, weight, number of units within the item, and size. In another embodiment, the mat 101 (FIG. 1) is configured to identify items via manual user input. More particularly, the user 109 (FIG. 1) can manually input the item name and weight via the I/O device 107 (FIG. 1). When the item 118 (FIG. 1) is identified, the mat 101 (FIG. 1) automatically receives a starting weight and the predetermined threshold weight of the item 118 (FIG. 1).

Optionally, the user 109 (FIG. 1) can set a threshold weight of the item 118 (FIG. 1), as indicated in block 302. This allows each user to specify when to receive notifications that one or more items 118 (FIG. 1) is running low in inventory. As indicated in block 302, the mat 101 (FIG. 1) is configured to continuously monitor the weight of the item 118 (FIG. 1) via the scale 102 (FIG. 1) to determine whether the weight of the item 118 (FIG. 1) falls below the predetermined threshold weight 303.

As indicated in block 304, when the weight of the item 118 (FIG. 1) falls below the predetermined threshold weight, the mat 101 (FIG. 1), via the MCU 105 (FIG. 1) determines whether to automatically replenish the item 118 (FIG. 1). If the item 118 (FIG. 1) is to be automatically replenished as specified by the user 109 (FIG. 1), for example, in a user-specific setting, the mat 101 (FIG. 1), via the MCU 105 (FIG. 1) is configured to place an order for the item 309, for example, in a predetermined quantity from an online store, for example, where a purchase was previously made, from a user's preferred vendor, or from a store that offers the best price. Thereafter, the user can confirm the order or cancel/change the order before it is processed.

If the user 109 (FIG. 1) has not specified that the item 118 (FIG. 1) should be automatically replenished, the mat 101 (FIG. 1) is configured to wirelessly transmit a notification, via the communication module 103 (FIG. 1) to the user device 108 (FIG. 1), as indicated in block 305. Without limitation, the mat 101 (FIG. 1) may transmit the notification via various means, such as email, text message, banner notification, and the like, for example, via the user interface 117 (FIG. 1). In some embodiments, the user can customize the method of notification, including the frequency of notification, number of notifications, and the means of notification (e.g., audible, tactile, visual, or any combination thereof).

Upon receiving notification, the user 109 (FIG. 1) is prompted to replenish the item via the user device 108 (FIG. 1), as indicated in block 306. If the user 109 (FIG. 1) wishes to replenish the item 118 (FIG. 1) 307, the user 109 (FIG. 1) can replenish the item 118 (FIG. 1) by purchasing it from an online store or a virtual store front accessible via a website 116 (FIG. 1) and placing an order 309. Alternatively, if the user does not wish to replenish the item 118 (FIG. 1) 307 the user can order another item 308, cancel the item, and/or order additional items.

Upon placing the order, the user 109 (FIG. 1) is prompted to confirm the order 310 via the user device 108 (FIG. 1), as indicated in block 310. In this regard, the user 109 (FIG. 1) can confirm the item purchased, the quantity of the item purchased, the mailing address, the billing address, the payment method, and the like. As indicated in block 311, the order request is transmitted to a merchant server 110 or a store (that operates the merchant server 110 (FIG. 1)) that fulfills the order request.

As indicated in block 312, the merchant or a store entity that receives the order confirmation forwards the order request to a store entity or a merchant 111 (FIG. 1) that can fulfill the order. The store or the merchant 111 (FIG. 1) can complete the order by delivering the ordered item to the user 109 (FIG. 1) (i.e., user's mailing address), as indicated in block 313.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A device for managing inventory, comprising:
a mat comprising a microcontroller having instructions stored thereon, wherein said microcontroller is connected to a power supply, a scale, and a communication module;
said scale configured to continuously measure a weight of an item placed on said mat;
said microcontroller configured to determine whether said weight of said item is below a predetermined threshold weight, wherein said predetermined threshold weight indicates that said item is a low inventory item; and
said communication module configured to transmit a notification to a user device if said weight of said item is below said predetermined threshold weight, wherein said user device is communicably coupled to said mat.

2. The device of claim 1, wherein said mat further comprises a scanner;
said scanner configured to scan a bar code disposed on said item, wherein said bar code comprises identifying data associated with said item.

3. The device of claim 1, wherein said microcontroller is further configured to automatically place an order for said item to replenish said item.

4. The device of claim 1, wherein said notification comprises a link that can be activated to show details about said item.

5. The device of claim 1, wherein said mat is communicably coupled to a database;
said database comprising item identification and item weight for each of said item.

6. A system for managing inventory, comprising:
a mat comprising a microcontroller having instructions stored thereon, wherein said microcontroller is connected to a power supply, a scale, and a communication module;
said scale configured to continuously measure a weight of an item placed on said mat;
said microcontroller configured to determine whether said weight of said item is below a predetermined threshold weight, wherein said predetermined threshold weight indicates that said item is a low inventory item; and
a user device, said user device configured to communicate with said mat and a merchant server, wherein said user device is configured to place an order for said item via said merchant server, upon receiving a notification from said mat via said communication module, if said weight of said item is below said predetermined threshold weight.

7. The system of claim 6, wherein said mat further comprises a scanner;
said scanner configured to scan a bar code disposed on said item, wherein said bar code comprises identifying data associated with said item.

8. The system of claim 6, wherein said microcontroller is further configured to automatically place an order for said item to replenish said item, and wherein said user device is further configured to confirm said order.

9. The system of claim 6, wherein said notification comprises a link that can be activated to show details about said item.

10. The system of claim 6, wherein said mat is communicably coupled to a first database;
said first database comprising item identification and item weight for each of said item.

11. The system of claim 6, wherein said merchant server is communicably coupled to a second database;
said second database comprising order numbers associated with each of said order and customer data.

12. A computer-implemented method for replenishing items, comprising executing on a processor the steps of:
identifying an item that is placed on a mat via a microcontroller of said mat, wherein said microcontroller is in communication with a database that comprises item identification associated with said item;
continuously monitoring a weight of said item via a scale of said mat;
determining via said microcontroller of said mat whether said weight of said item is below a predetermined threshold weight; and
if said weight of said item is below said predetermined threshold weight;
transmitting a notification via a communication module of said mat to a user device communicably coupled to said mat.

13. The method of claim 12, further comprising the steps of:
transmitting a prompt said user device to replenish said item.

14. The method of claim 12, further comprising the steps of:
placing an order from an online store for said item via said microcontroller to replenish said item; and
confirming said order for said item via a user interface of said user device.

15. The method of claim 12, wherein the step of identifying said item comprises the steps of scanning a bar code disposed on said item, wherein said bar code comprises said item identification associated with said item.

16. The method of claim 12, wherein the step of identifying said item comprises the steps of entering an item name and a starting weight of said item via a input/output device of said mat.

17. The method of claim 12, further comprising the steps of lowering or raising said predetermined threshold weight.
